(19) United States
(12) Patent Application Publication
(10) Pub. No.: US 2015/0277170 A1
(43) Pub. Date: Oct. 1, 2015

(54) LIQUID CRYSTAL DISPLAY DEVICE

(71) Applicant: SHARP KABUSHIKI KAISHA, Osaka-shi, Osaka (JP)

(72) Inventor: Kazuma Hirao, Osaka (JP)

(73) Assignee: Sharp Kabushiki Kaisha, Osaka (JP)

(21) Appl. No.: 14/440,575

(22) PCT Filed: Nov. 20, 2013
(86) PCT No.: PCT/JP2013/081318

§ 371 Date: May 4, 2015

(30) Foreign Application Priority Data
Nov. 21, 2012 (JP) 2012-255634

(51) Int. Cl. G02F 1/133; G02F 1/1368; G02F 1/1362

(52) U.S. Cl. CPC G02F 1/13306; G02F 1/136286; G02F 1/1368; G02F 2001/133397

(57) ABSTRACT

A liquid crystal display device according to the present invention includes a liquid crystal layer, a data signal line, a scan signal line, a transistor connected to the data signal line and the scan signal line, a pixel electrode connected to the data signal line via the transistor, a conductor and power supply wiring, the pixel electrode and the conductor forming a first capacitance and the conductor and the power supply wiring being connected to each other via a second capacitance. With this configuration, a residual image at the time of turning off of the power supply of the image display device is reduced.

### TECHNICAL FIELD

The present invention relates to a liquid crystal display device.

### BACKGROUND ART

FIG. 18 is a block diagram illustrating an example configuration of a liquid crystal display device of the related art (active matrix type). A liquid crystal display device 100 includes a liquid crystal panel 10, a signal line driver circuit (source driver) 20, a scan line driver circuit (gate driver) 30, and a liquid crystal driver circuit 40 provided around the liquid crystal panel 10.

In the liquid crystal panel 10, as illustrated in FIG. 18, a plurality of image signal lines (data signal lines) 11 and a plurality of scan signal lines 12 are arranged in a matrix so as to intersect each other, and an auxiliary capacitance wiring line 13 is arranged parallel to each scan signal line 12.

The image signal lines 11 are connected to the signal line driver circuit 20, the scan signal lines 12 are connected to the scan line driver circuit 30, and the auxiliary capacitance wiring lines 13 are connected to CS trunk wiring 46 connected to the liquid crystal driver circuit 40.

Transistors 14 are respectively provided as switching elements at positions near the intersections of the image signal lines 11 and the scan signal lines 12, and a control terminal (gate) of each transistor 14 is connected to the corresponding scan signal line 12. One driving terminal (one of source and drain) of each transistor 14 is connected to the corresponding image signal line 11. In addition, the other of the driving terminals (other of source and drain) of each transistor 14 is connected to a pixel electrode 15 provided in a region surrounded by the image signal lines 11 and the scan signal lines 12, and a common electrode 17 (COM) is provided so as to oppose the pixel electrode 15 with a liquid crystal layer serving as a display medium interposed between the common electrode 17 and the pixel electrode 15. A liquid crystal capacitance 19 (pixel) is formed by the pixel electrode 15, the common electrode 17 and the liquid crystal layer interposed between these electrodes. Furthermore, the corresponding auxiliary capacitance wiring line 13 is connected to the other driving terminal of the transistor 14 via a corresponding auxiliary capacitance 18.

A system power supply potential Vcc generated by a power supply circuit 77 outside the liquid crystal display device is supplied via power supply wiring 41 to the liquid crystal driver circuit 40. In addition, the liquid crystal driver circuit 40 supplies a potential Vcom of the common electrode 17 to Vcom wiring 45 connected to the common electrode 17. Furthermore, a gate-on power supply potential VGH is supplied from the liquid crystal driver circuit 40 to the gate driver 30 via power supply wiring 43, a gate-off power supply potential VGL is supplied from the liquid crystal driver circuit 40 to the gate driver 30 via power supply wiring 44, and an analog power supply potential VLS is supplied from the liquid crystal driver circuit 40 to the source driver 20 via power supply wiring 42.

With this configuration, a scan voltage is supplied from the scan signal line driver circuit 30 to the gate of the transistor 14 via the corresponding scan signal line 12, and a signal voltage corresponding to a display signal is supplied from the signal line driver circuit 20 to the source or drain of the transistor 14 via the corresponding image signal line 11 in this active-matrix-type liquid crystal display device 1. Thus, the plurality of liquid crystal display pixels arranged in a matrix inside the liquid crystal panel 10 are individually driven and a desired display pattern is obtained on the display screen of the liquid crystal panel 10.

Here, when the power supply of the liquid crystal display device is turned off, the outputs of the signal line driver circuit 20 and the scan signal line driver circuit 30 transition to a high impedance state. At this time, there is no escape route for charge that has accumulated in the liquid crystal capacitances 19 and charge that has accumulated in the auxiliary capacitances 18. The charge is only slowly discharged via a leakage current, and therefore a considerable amount of time (on the order of several seconds) is required until the potential of the pixel electrodes 15 and the potential of the common electrode 17 become substantially the same potential. This time (on the order of several seconds) is a comparatively long time for the human eye and is sufficient to be visually recognizable. Therefore, it appears that the display screen, just before the power supply is turned off, is held and then gradually disappears, and for a certain fixed period an image such as a fuzzy residual image is clearly visually recognized. In addition, there is also a problem in that the liquid crystal display panel 10 is degraded by residual voltages applied to the display pixels.

Hereafter, a problem of the active-matrix-type liquid crystal display device 1 of the related art will be described in detail using FIG. 19. FIG. 19 is a signal waveform diagram illustrating an example of signal waveforms of the individual parts of the liquid crystal display device 100 illustrated in FIG. 18 when the power supply is turned off.

Although a high level potential (VGH) that causes the transistor 14 to transition to an on state (selected state) and a low level potential (VGL) that causes the transistor 14 to transition to an off state (unselected state) are supplied to each scan signal line 12, ordinarily only one scan signal line 12 among the plurality of scan signal lines 12 is in the selected state and all of the remaining scan signal lines 12 are in the unselected state, and therefore the potential supplied to the scan signal lines 12 in FIG. 19 is VGL. In the liquid crystal display device 100, alternating current driving is performed in order to prevent degradation of the liquid crystal. In FIG. 19, a potential written to a pixel electrode of a positive polarity with respect to Vcom is denoted as VS+ and a potential written to a pixel electrode of a negative polarity with respect to Vcom is denoted as VS−.

The potentials of the individual parts in a normal operating state are VGL, ground potential (0 V), VS−, Vcc, Vcom and VS+ (Vcom is substantially in the middle between VS+ and VS−) in order from the low potential side as indicated on the left side of the dotted line in FIG. 19.

When the system power supply of the liquid crystal display device 100 is turned off, the outputs of the image signal line driver circuit 20 and the scan line driver circuit 30 transition to a high impedance state and the charge of the pixel electrodes 15 is slowly discharged as a leakage current via high resistance paths of the surrounding wiring (image signal lines 11, scan signal lines 12 and auxiliary capacitance wiring lines 13), the transistors 14 and the liquid crystal display device 100. At this time, the transistors 14 take a long time to transition to the off state, and therefore a potential difference is generated between the common electrode 17 and the pixel electrodes 15 for a long period of time due to the charge in the liquid crystal capacitance 19 and the auxiliary capacitances 18. This is the cause of a residual image.

For example, Patent Documents 1 to 4 can be cited as documents relating to this problem.

### RELATED ART DOCUMENTS

### Patent Documents

Patent Document 1: Japanese Patent Application Laid-Open Publication “Japanese Patent Application Laid-Open Publication No. H10-214067”

Patent Document 2: Japanese Patent Application Laid-Open Publication “Japanese Patent Application Laid-Open Publication No. 2001-159876”

Patent Document 3: Japanese Patent No. 4557649

Patent Document 4: Japanese Patent Application Laid-Open Publication “Japanese Patent Application Laid-Open Publication No. 2008-241749”

### SUMMARY OF THE INVENTION

### Problems to be Solved by the Invention

In Patent Document 1, an auxiliary power supply for allowing a circuit to operate even after the power supply of the liquid crystal display device is turned off and a power-supply-off detection unit that detects turning off of the power supply of the liquid crystal display device are required.

In Patent Document 2, it is necessary that a residual image off signal for performing driving in which the polarity of a gradation voltage supplied to a source bus line is controlled be input prior to cutting off of the power supply so that a difference between a gate voltage Vg and a drain voltage Vd of at least some of the transistors becomes a voltage difference Vgd with which charge held in liquid crystal among voltage differences seen at the time of display driving is caused to be more rapidly discharged, before the end of at least one vertical period in which the power supply of the liquid crystal display device is turned off.

In Patent Document 4, a power supply off detection unit that detects turning off of the power supply is necessary.

In Patent Document 3, there is a problem in that although an auxiliary power supply, a power supply off detection unit that detects turning off of a power supply, and generation of an advance signal prior to cutting off of the power supply are not necessary, it is necessary to raise the potential of the auxiliary capacitance wiring lines 13 to a high voltage in advance, and therefore it is difficult for this configuration to be adopted in a CS on-gate liquid crystal panel. In addition, correction of pixel defects in a normally black mode (black spot correction) is difficult.

An object of the present invention is to easily suppress a residual image at a time when the power supply is turned off.

### Means for Solving the Problems

A liquid crystal display device of the present invention includes: a liquid crystal layer; a data signal line; a scan signal line; a transistor connected to the data signal line and the scan signal line; a pixel electrode connected to the data signal line via the transistor; a conductor connected to the pixel electrode via a first capacitor; and a power supply wiring line, wherein the conductor and the power supply wiring line are connected to each other via a second capacitor.

### Effects of the Invention

With the liquid crystal display device, a residual image at a time when the power supply is turned off can be easily suppressed.

### BRIEF DESCRIPTION OF THE DRAWINGS

FIG. 1 is a block diagram illustrating a configuration of a liquid crystal display device according to Embodiment 1.

FIG. 2 is a circuit diagram illustrating an example configuration of an important part of a liquid crystal panel of FIG. 1.

FIG. 3 is a signal waveform diagram illustrating an example of signal waveforms of individual parts of the liquid crystal display device of FIG. 1 when the power supply is turned off.

FIG. 4 is a waveform diagram regarding an effect of Embodiment 1.

FIG. 5 is a block diagram illustrating another configuration of the liquid crystal display device according to Embodiment 1.

FIG. 6 is a block diagram illustrating yet another configuration of the liquid crystal display device according to Embodiment 1.

FIG. 7 is a block diagram illustrating yet another configuration of the liquid crystal display device according to Embodiment 1.

FIG. 8 is a block diagram illustrating yet another configuration of the liquid crystal display device according to Embodiment 1.

FIG. 9 is a block diagram illustrating yet another configuration of the liquid crystal display device according to Embodiment 1.

FIG. 10 is a block diagram illustrating a configuration of a liquid crystal display device according to Embodiment 2.

FIG. 11 is a signal waveform diagram illustrating an example of signal waveforms of individual parts of the liquid crystal display device of FIG. 10 when the power supply is turned off.

FIG. 12 is a block diagram illustrating another configuration of the liquid crystal display device according to Embodiment 2.

FIG. 13 is a block diagram illustrating yet another configuration of the liquid crystal display device according to Embodiment 2.

FIG. 14 is a block diagram illustrating yet another configuration of the liquid crystal display device according to Embodiment 2.

FIG. 15 is a block diagram illustrating yet another configuration of the liquid crystal display device according to Embodiment 2.

FIG. 16 is a block diagram illustrating a configuration of a liquid crystal display device according to Embodiment 3.

FIG. 17 is a signal waveform diagram illustrating an example of signal waveforms of individual parts of the liquid crystal display device of FIG. 13 when the power supply is turned off.

FIG. 18 is a block diagram illustrating a configuration of a liquid crystal display device of the related art.

FIG. 19 is a signal waveform diagram illustrating an example of signal waveforms of individual parts of the liquid crystal display device of the related art when the power supply is turned off.

FIG. 20 is a waveform diagram regarding a problem of the liquid crystal display device of the related art.

### DETAILED DESCRIPTION OF EMBODIMENTS

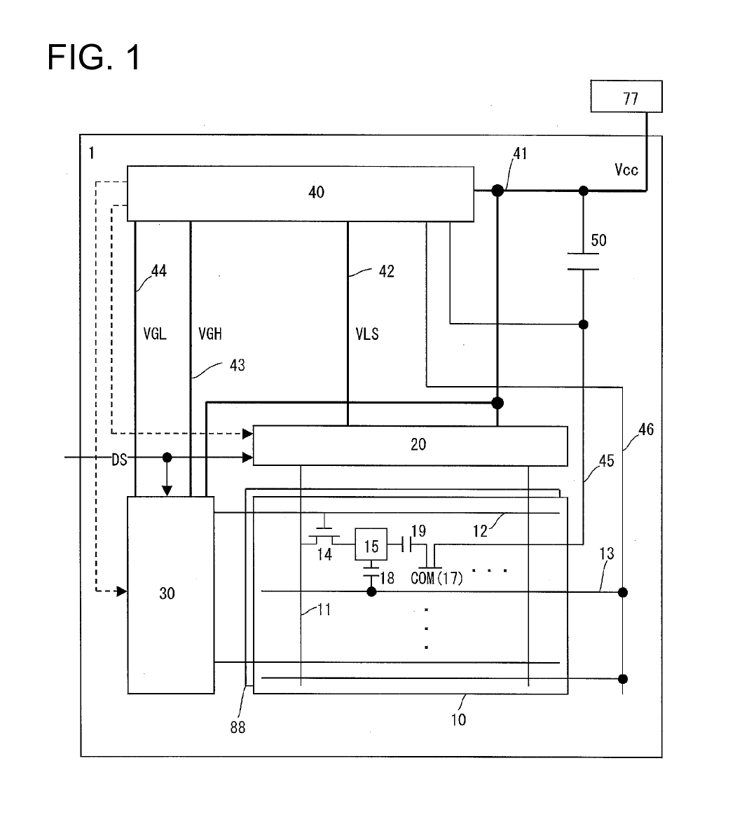

Hereafter, a case in which the present invention is applied to an active-matrix-type liquid crystal display device will be described while referring to FIGS. 1 to 20.

### Embodiment 1

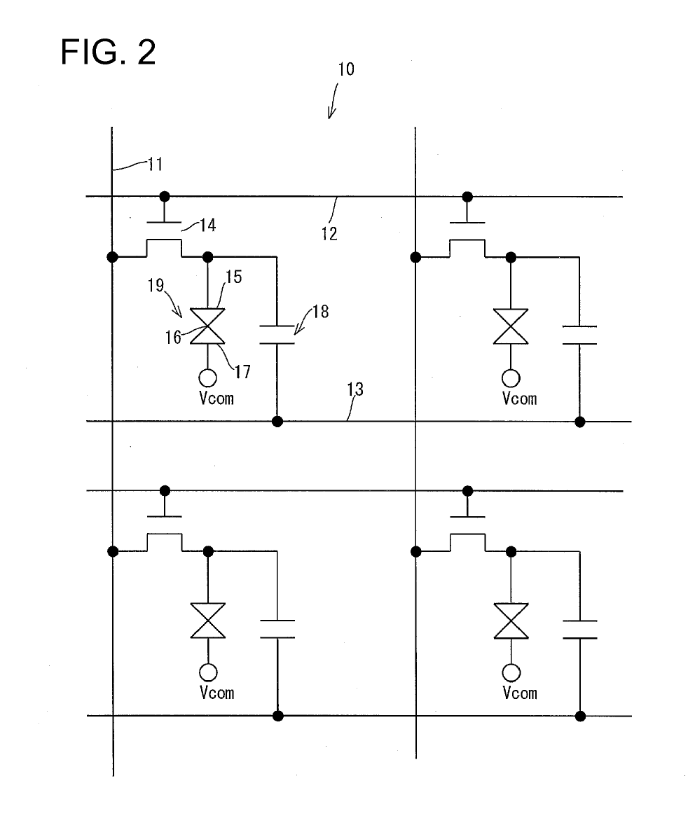

FIG. 1 is a block diagram illustrating an example configuration of a liquid crystal display device, and FIG. 2 is a circuit diagram illustrating an example pixel configuration of the liquid crystal panel of FIG. 1. As illustrated in FIG. 1, a liquid crystal display device 1 includes a liquid crystal panel 10, a backlight 88, a signal line driver circuit (source driver) 20, a scan line driver circuit (gate driver) 30, and a liquid crystal driver circuit 40 provided around the liquid crystal panel 10.

In the liquid crystal panel 10, as illustrated in FIGS. 1 and 2, a plurality of image signal lines (data signal lines) 11 and a plurality of scan signal lines 12 are arranged in a matrix so as to intersect each other and an auxiliary capacitance wiring line 13 is arranged parallel to each scan signal line 12.

The image signal lines 11 are connected to the signal line driver circuit 20, the scan signal lines 12 are connected to the scan line driver circuit 30, and the auxiliary capacitance wiring lines 13 are connected to CS trunk wiring 46.

Transistors 14 (N-channel-type TFTs) are respectively provided as switching elements at positions near the intersections of the image signal lines 11 and the scan signal lines 12. A control terminal (gate) of each transistor 14 is connected to the corresponding scan signal line 12, and one driving terminal (one of source and drain) of each transistor 14 is connected to the corresponding image signal line 11. In addition, the other of the driving terminals (other of source and drain) of each transistor 14 is connected to a pixel electrode 15 provided in a region surrounded by the image signal lines 11 and the scan signal lines 12, and a common electrode 17 (COM) is provided so as to oppose the pixel electrode 15 with a liquid crystal layer, which is a display medium, interposed between the common electrode 17 and the pixel electrode 15. A liquid crystal capacitance 19 (first capacitance) is formed by the pixel electrode 15, the common electrode 17 and the liquid crystal layer. Furthermore, the other driving terminal of the transistor 14 is connected to the corresponding auxiliary capacitance wiring line 13 via a corresponding auxiliary capacitance 18.

A system power supply potential Vcc generated by a power supply circuit 77 outside the liquid crystal display device is supplied via power supply wiring 41 to the liquid crystal driver circuit 40. On the basis of this system power supply potential Vcc, the liquid crystal driver circuit 40 supplies a gate-on power supply potential VGH (selected state voltage) via power supply wiring 43 and supplies a gate-off power supply potential VGL (unselected state voltage) via power supply wiring 44 to the gate driver 30, and in addition supplies an analog power supply potential VLS to the source driver 20 via power supply wiring 42. A data signal potential to be output to the image signal lines 11 is generated in the source driver 20 on the basis of the analog power supply potential VLS.

In addition, the liquid crystal driver circuit 40 supplies a common electrode potential Vcom to the common electrode 17 via Vcom wiring 45 and supplies a CS potential Vcs to the auxiliary capacitance wiring lines 13 via the CS trunk wiring 46. Vcs may be the same potential as Vcom.

A particularly noteworthy feature of Embodiment 1 is that a capacitance 50 (second capacitance) is provided between the Vcom wiring 45 connected to the common electrode 17 and the power supply wiring 41 through which the system power supply potential Vcc of the liquid crystal display device 1 is supplied.

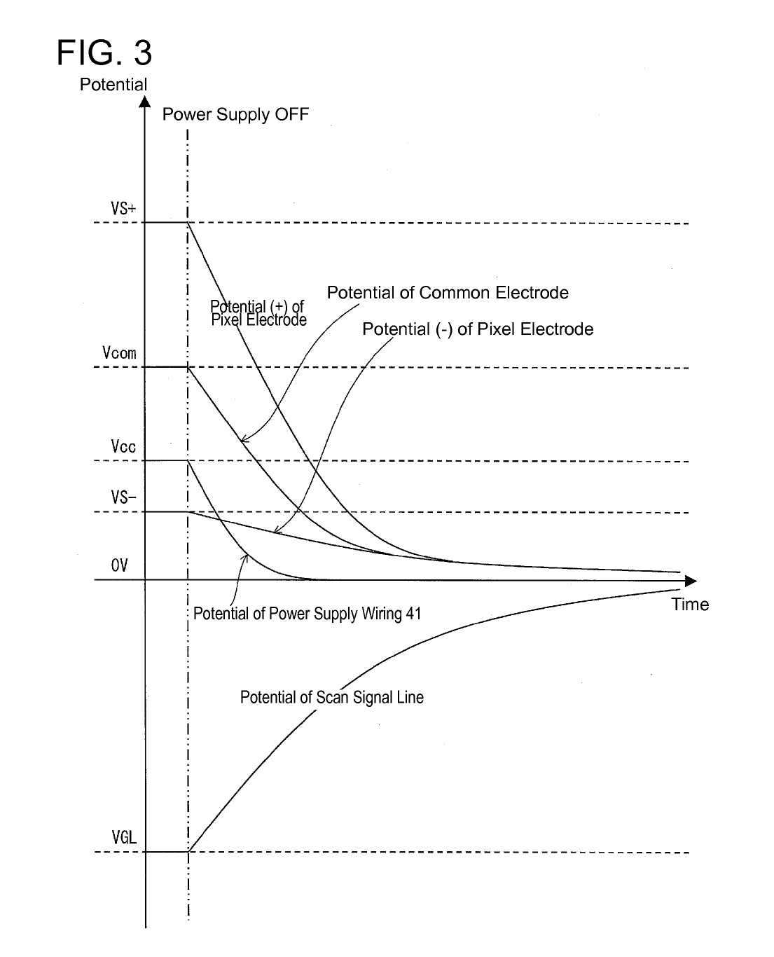

FIG. 3 is a signal waveform diagram illustrating an example of signal waveforms of individual parts of the liquid crystal display device 1 when the power supply is turned off. In a normal state, the scan signal lines 12 can take the gate-on potential VGH, which causes the transistors 14 to transition to an on state (selected state), and the gate-off potential VGL, which causes the transistors 14 to transition to an off state (unselected state), but usually only one scan signal line is in the selected state and the remainder are in the unselected state, and therefore the potential of these scan signal lines 12 is the gate-off potential VGL. In the liquid crystal display device 1, typical alternating current driving is performed, and therefore, in FIG. 3, a data signal potential (potential written to pixel electrode 15) of a positive polarity with respect to Vcom (potential of common electrode 17) is indicated by VS+, and a data signal potential (potential written to pixel electrode 15) of a negative polarity with respect to Vcom is indicated by VS−.

In the normal operating state, the potentials of the respective parts are VGL, ground potential (0 V), VS−, Vcc, Vcom and VS+ (Vcom is substantially in the middle between VS+ and VS−) in order from the low potential side as indicated on the left side from the two-dot slash line (time when power supply is turned off) in FIG. 3, and there is no particular effect from the capacitance 50.

When the system power supply of the liquid crystal display device 1 is turned off, the outputs of the image signal line driver circuit 20 and the scan line driver circuit 30 transition to a high impedance state and the potentials of the scan signal lines 12 slowly increase due to natural discharge. On the other hand, since the system power supply potential rapidly decreases from Vcc, the potential of the common electrode 17 connected to the power supply wiring 41 via the capacitance 50 also rapidly decreases, and together with this, the potentials of the pixel electrodes 15 connected to the common electrode 17 via the liquid crystal capacitance 19 also rapidly decrease.

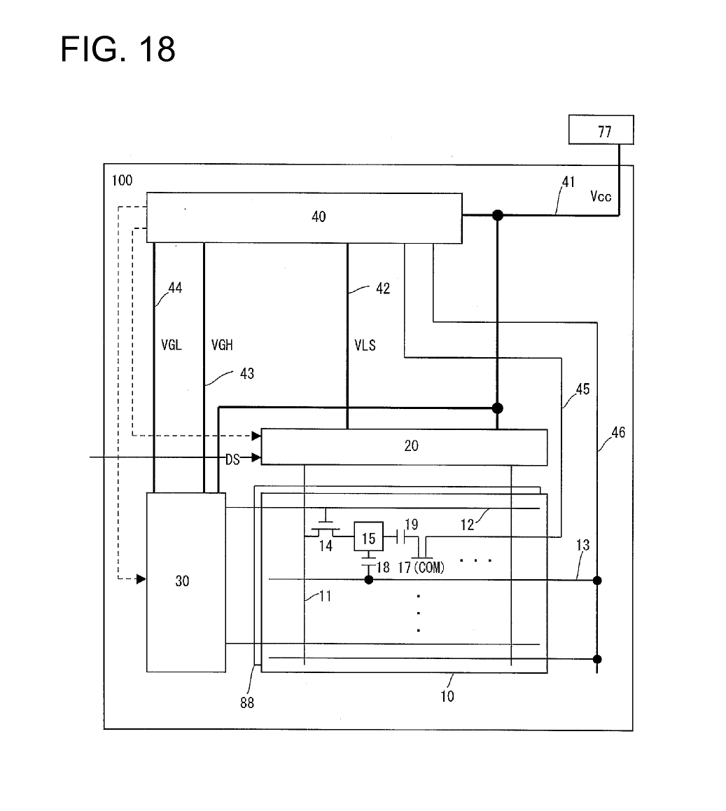

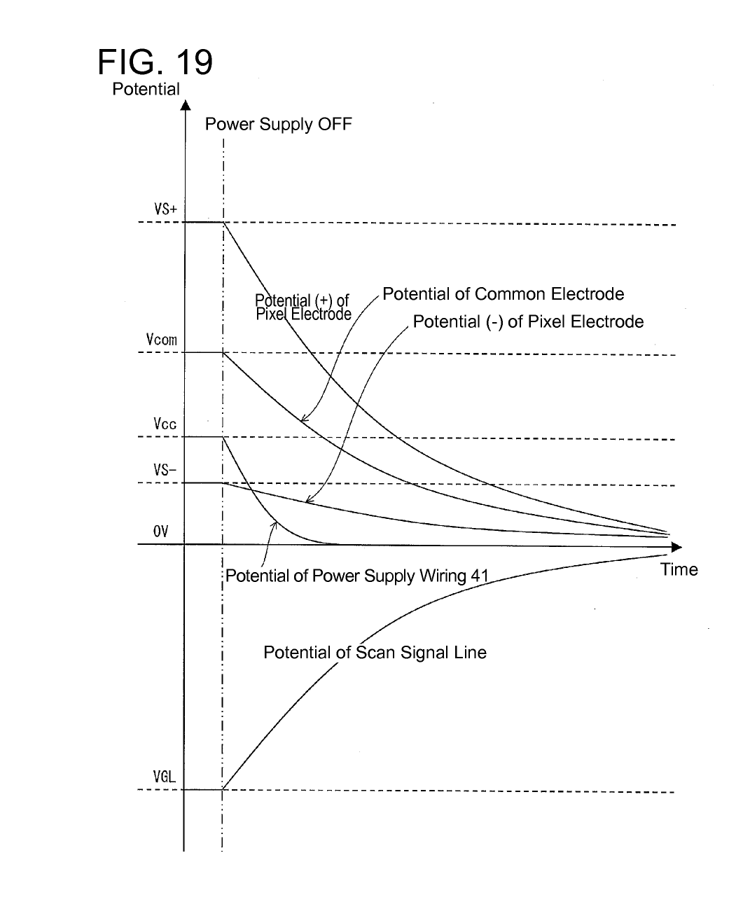

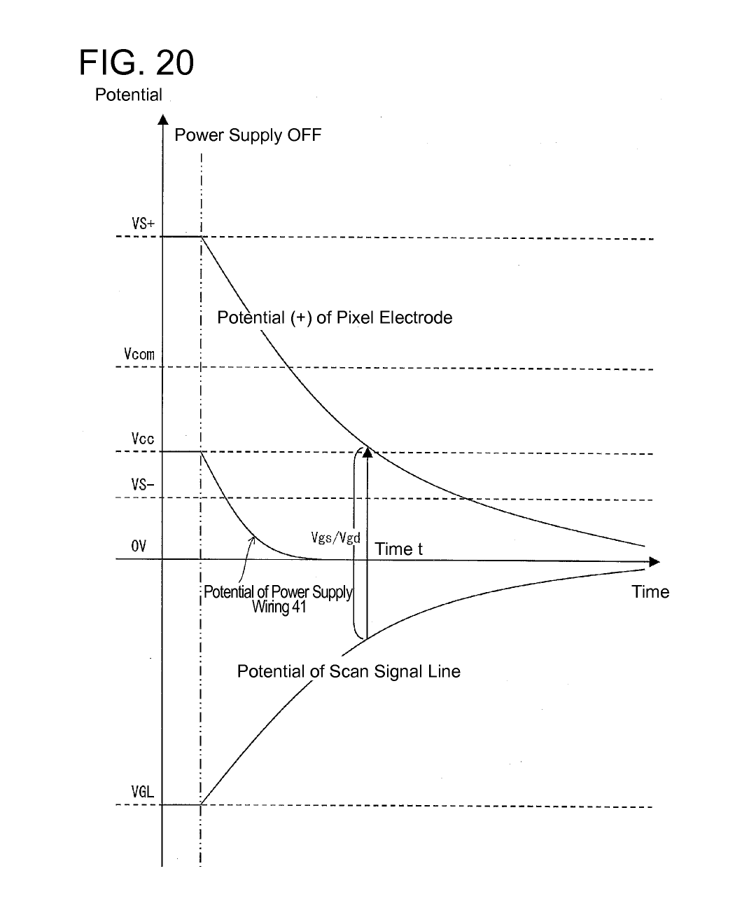

Here, the drain and the source of the transistors 14 (N channel) are not distinguished between, and the lower the potential of the source or the drain (Vgs/Vgd) with respect to the potential of the gate (scan signal line 12) becomes, the more OFF characteristics of the transistor 14 are reduced (increase in ON characteristics) and the larger a leakage current between the drain and the source becomes. In the related art illustrated in FIGS. 18 and 19, as illustrated in FIG. 20, it is clear that Vgs/Vgd at a time t after a certain period of time has elapsed from the power supply being turned off is high and that the OFF characteristics of the transistor 14 are also high (it is difficult for the charge of the pixel electrode 15 to escape toward the image signal line 11 side).

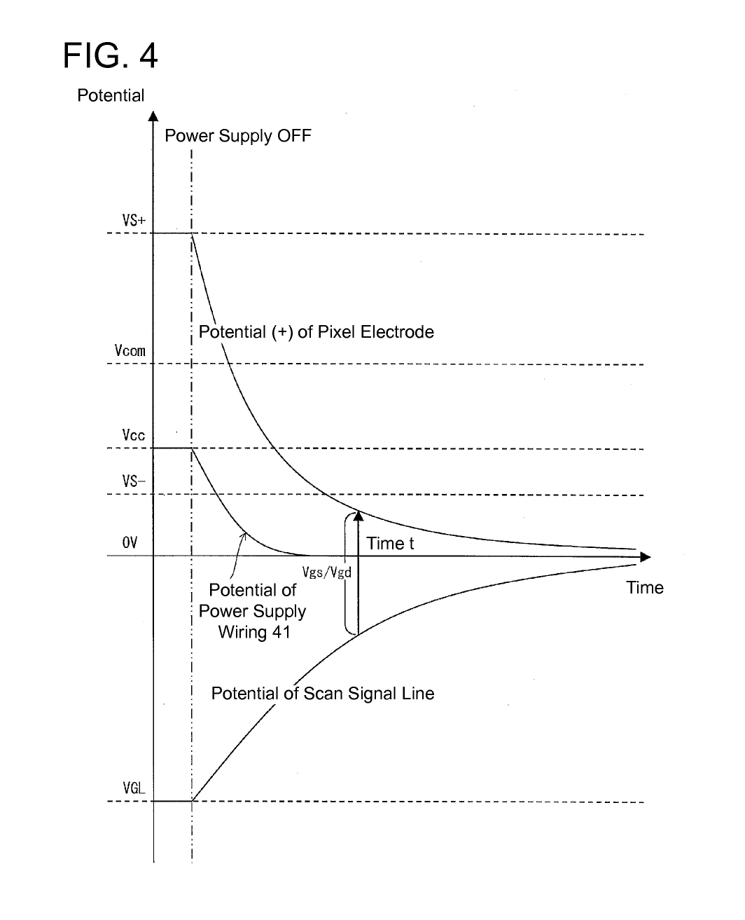

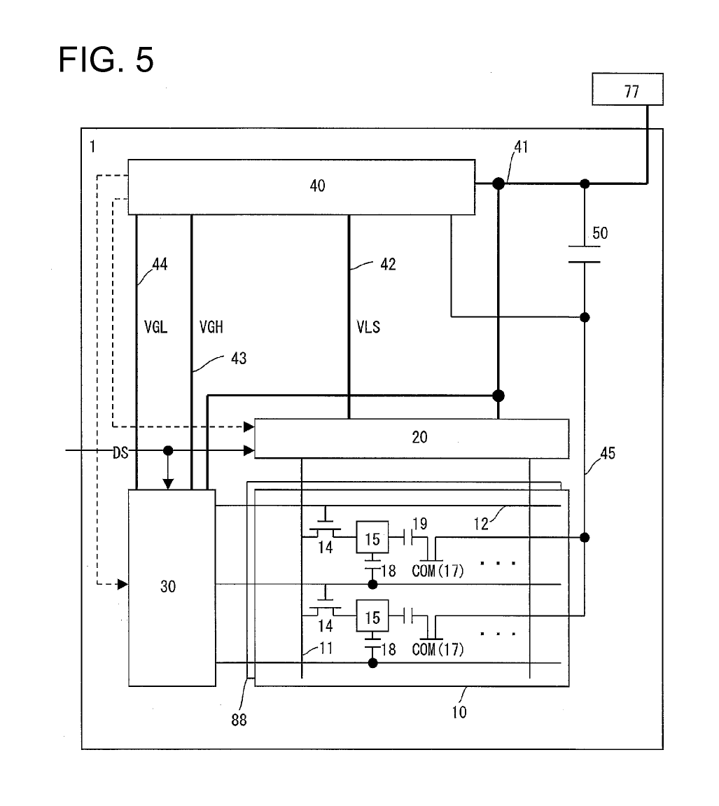

In contrast, in Embodiment 1 (refer to FIG. 4), the potential of the pixel electrode 15 rapidly decreases as described above, and compared with the related art (FIG. 20), Vgs/Vgd at the time t (potential of source or drain with respect to potential of gate) is low. Together with this, OFF characteristics of the transistor 14 are low and as a result a leakage current between the pixel electrode 15 and the image signal line 11 is large (charge of the pixel electrode 15 easily escapes toward the image signal line 11 side). Thus, a potential difference between the pixel electrode 15 and the common electrode 17 more rapidly decreases than in the case in FIGS. 19 and 20 and a residual image can be decreased. In addition, degradation of the liquid crystal panel 10 due to residual voltages of liquid crystal capacitance can also be suppressed. Furthermore, Embodiment 1 can also be applied to CS on-gate liquid crystal panels as illustrated in FIG. 5.

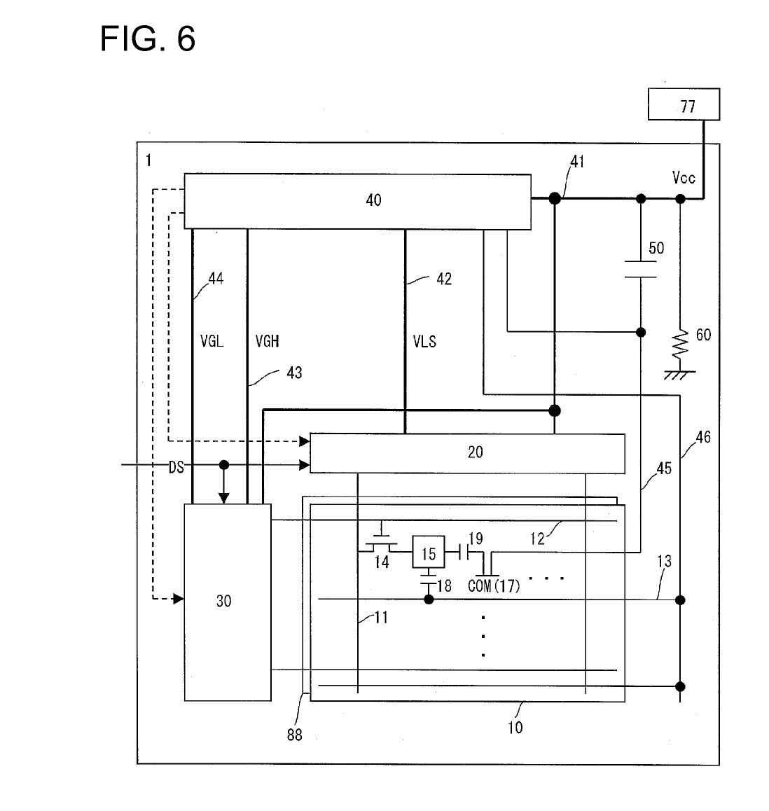

The effect of reducing a residual image can be further increased by providing a discharge circuit for speedily decreasing the system power supply potential. For example, in FIG. 6, the power supply wiring 41 is connected to ground via a resistor 60.

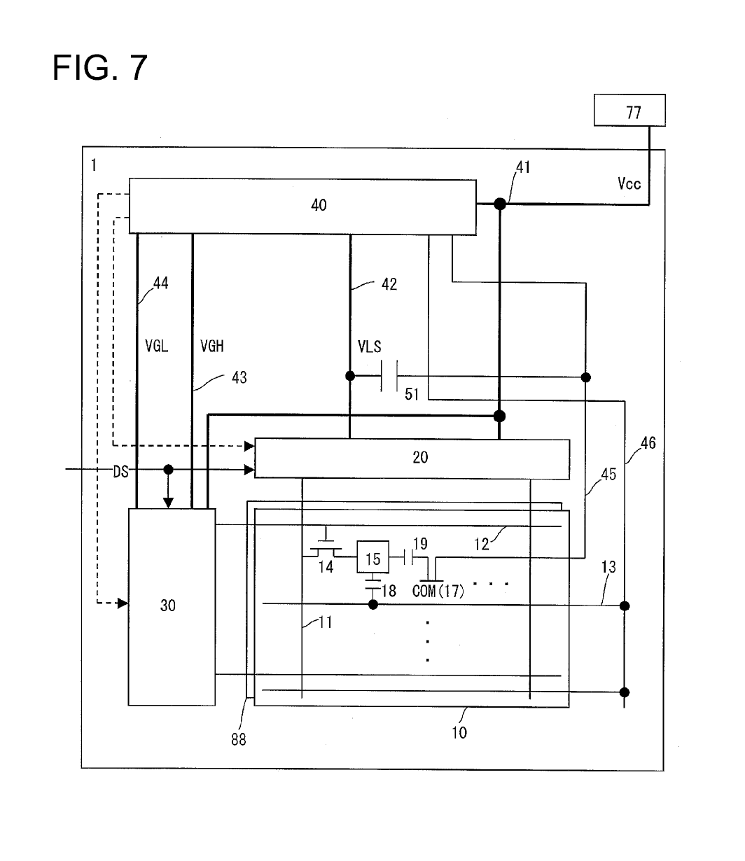

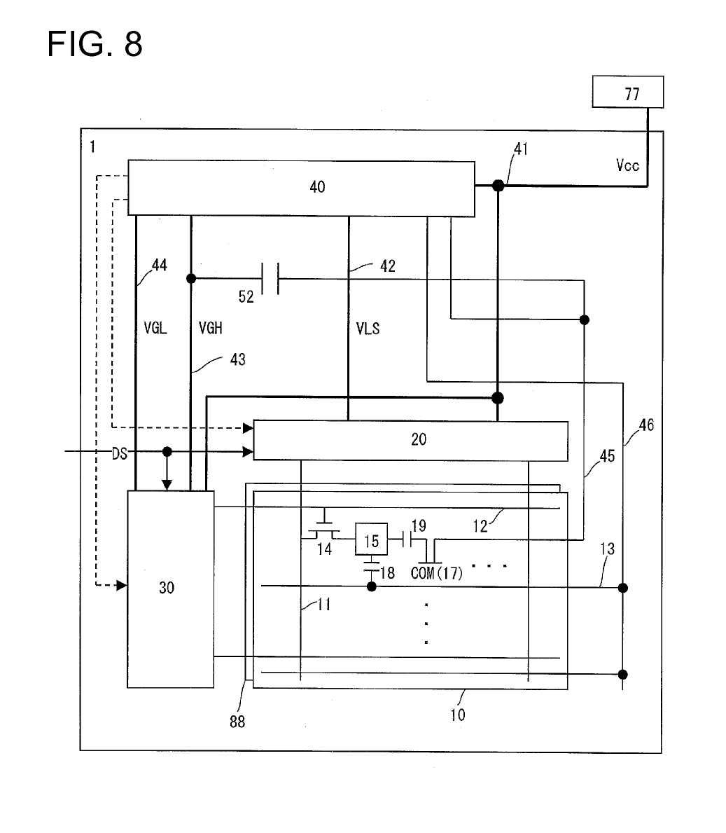

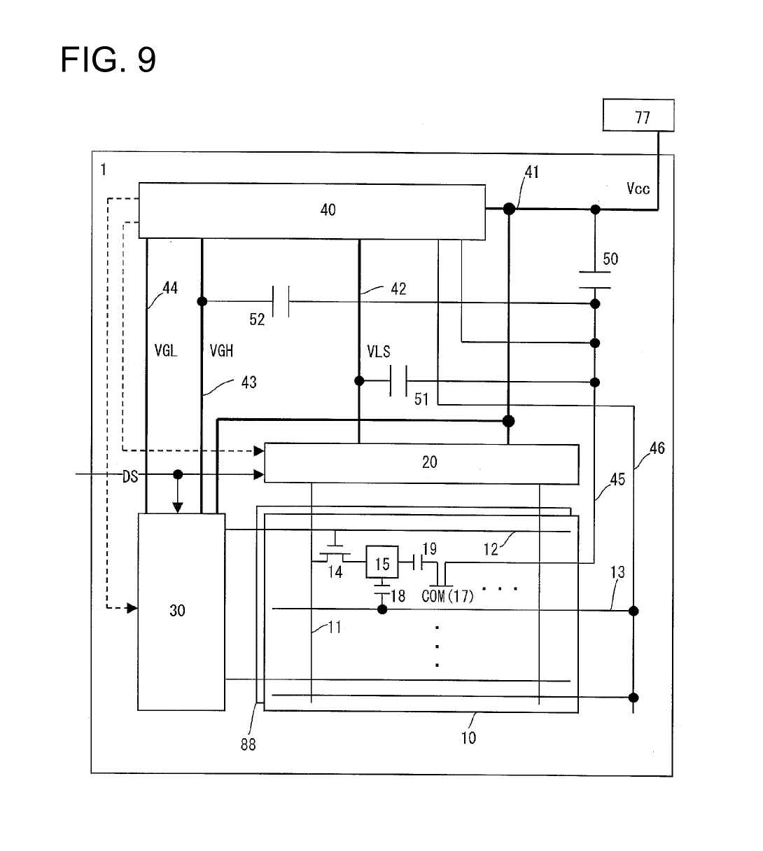

In addition, since the effect of reducing a residual image is dependent upon the voltage decrease (potential difference) of the system power supply and on the speed of the decrease (decrease in voltage per unit time) after the power supply is turned off, if there is power supply wiring for which the voltage decrease and decrease speed are greater than for the system power supply when the power supply is turned off, this power supply wiring and the common electrode 17 may be connected to each other via a capacitance. For example, in FIG. 7, the power supply wiring 42 through which the analog power supply potential VLS is supplied and the common electrode 17 are connected to each other via a capacitance 51. Since VLS is generally a higher potential than Vcc and decreases by a greater amount when the power supply is turned off, the effect of reducing a residual image is also larger. In addition, in FIG. 8, the power supply wiring 43 through which the gate-on power supply potential VGH is supplied and the common electrode 17 are connected to each other via a capacitance 52. Furthermore, in FIG. 9, the power supply wiring 41 through which the system power supply Vcc is supplied and the common electrode 17 are connected to each other via a capacitance 50, the power supply wiring 42 through which the analog power supply potential VLS is supplied and the common electrode 17 are connected to each other via a capacitance 51, and the power supply wiring 43 through which the gate-on power supply potential VGH is supplied and the common electrode 17 are connected to each other via a capacitance 52.

### Embodiment 2

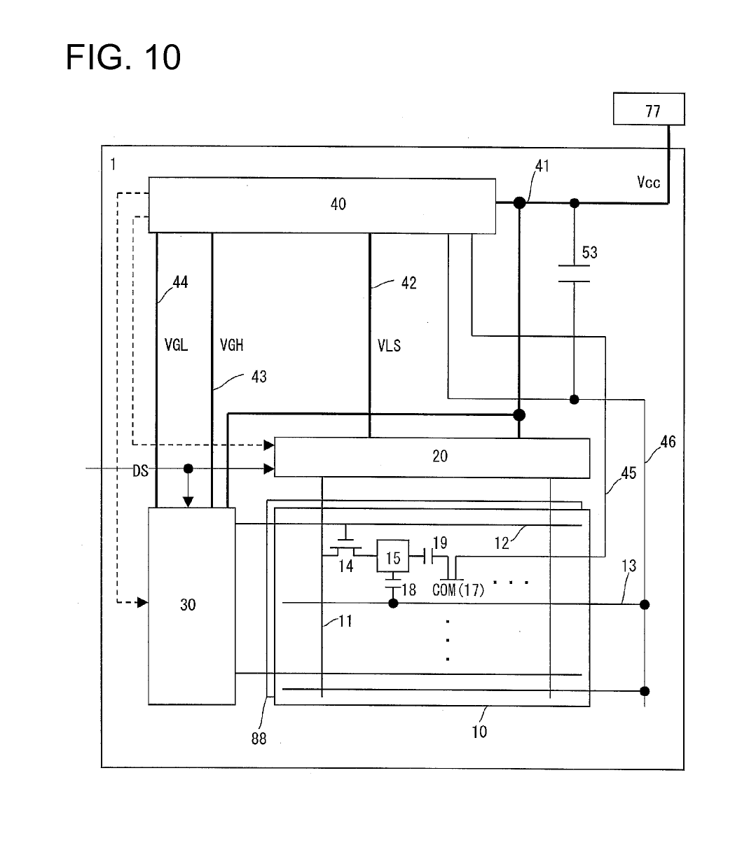

A particularly notable feature of Embodiment 2 is that, as illustrated in FIG. 10, a capacitance 53 (second capacitance) is provided between the CS trunk wiring 46 connected to the auxiliary capacitance wiring lines 13 and the power supply wiring 41 through which the system power supply potential Vcc of the liquid crystal display device 1 is supplied.

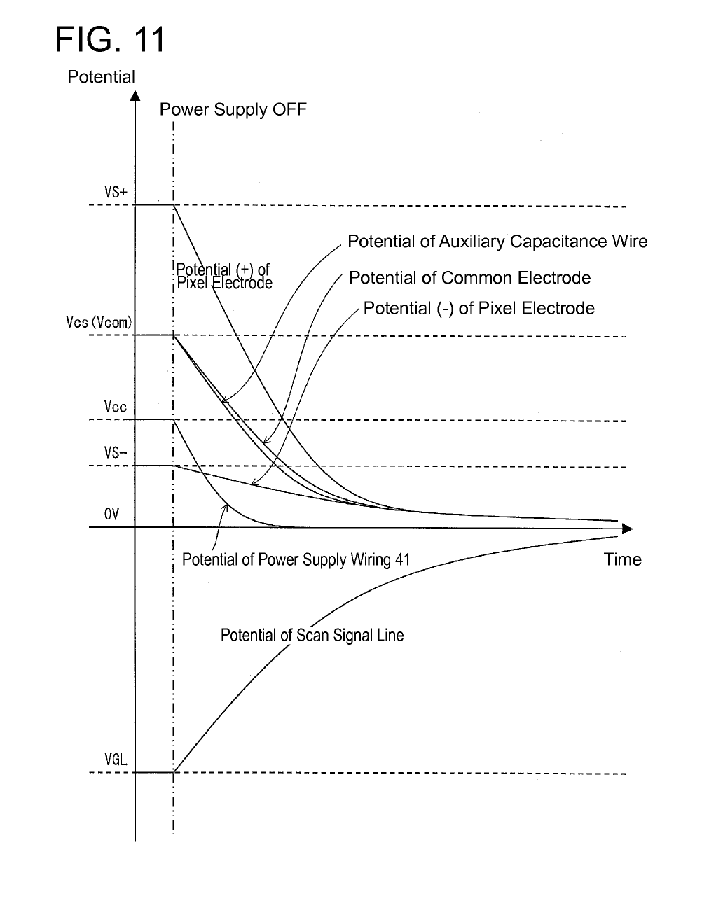

FIG. 11 is a signal waveform diagram illustrating an example of signal waveforms of individual parts of the liquid crystal display device 1 when the power supply is turned off.

In the normal operating state, the potentials of the respective parts are VGL, ground potential (0 V), VS−, Vcc, Vcs (Vcom) and VS+ (Vcom is substantially in the middle between VS+ and VS−) in order from the low potential side as indicated on the left side of the two-dot slash line in FIG. 11, and there is no particular effect from the capacitance 53.

When the system power supply of the liquid crystal display device 1 is turned off, the outputs of the image signal line driver circuit 20 and the scan line driver circuit 30 transition to a high impedance state and the potentials of the scan signal lines 12 slowly increase due to natural discharge. In contrast, since the system power supply potential rapidly decreases from Vcc, the potentials of the auxiliary capacitance wiring lines 13 connected to the power supply wiring 41 via the capacitance 53 also rapidly decrease, and together with this, the potentials of the pixel electrodes 15 connected to the auxiliary capacitance wiring lines 13 via the auxiliary capacitances 18 also rapidly decrease. That is, compared to the related art (FIGS. 19 and 20), the potential of the source or drain with respect to the potential of the gate of the transistor 14 rapidly decreases and together with this, the OFF characteristics of the transistor 14 decreases, and as a result a leakage current between the pixel electrode 15 and the image signal line 11, are large (charge of the pixel electrode 15 easily escapes toward the image signal line 11 side). Thus, a potential difference between the pixel electrode 15 and the common electrode 17 more rapidly decreases than in the case in FIG. 19 and a residual image can be decreased. In addition, degradation of the liquid crystal panel 10 due to residual voltages of liquid crystal capacitance can also be suppressed. Furthermore, Embodiment 2 can also be applied to a so-called IPS-type liquid crystal panel in which the pixel electrodes and the common electrode are formed on the same substrate.

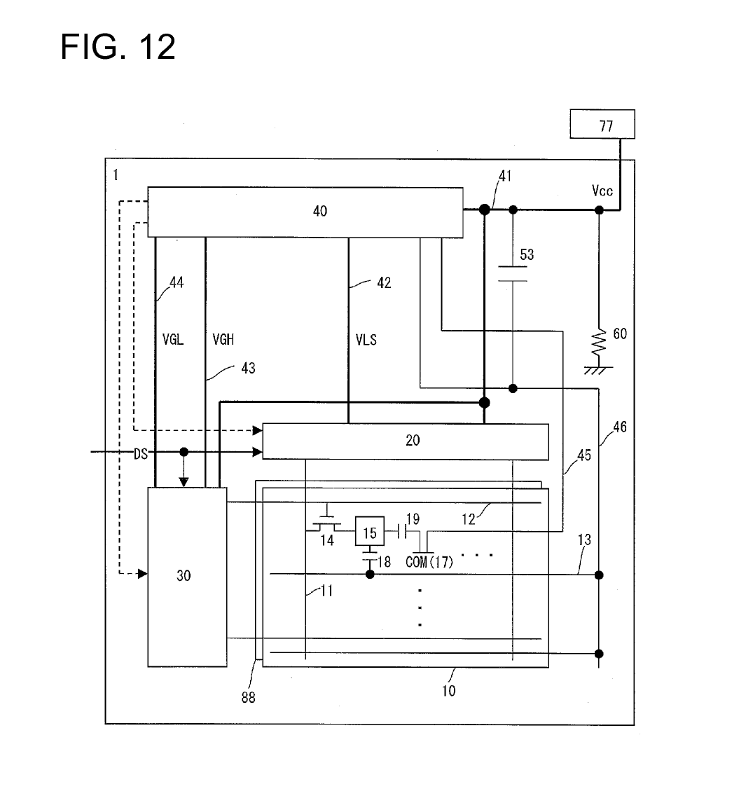

The effect of reducing a residual image can be further increased by providing a discharge circuit for speedily decreasing the system power supply potential. For example, in FIG. 12, the power supply wiring 41 is connected to ground via the resistor 60.

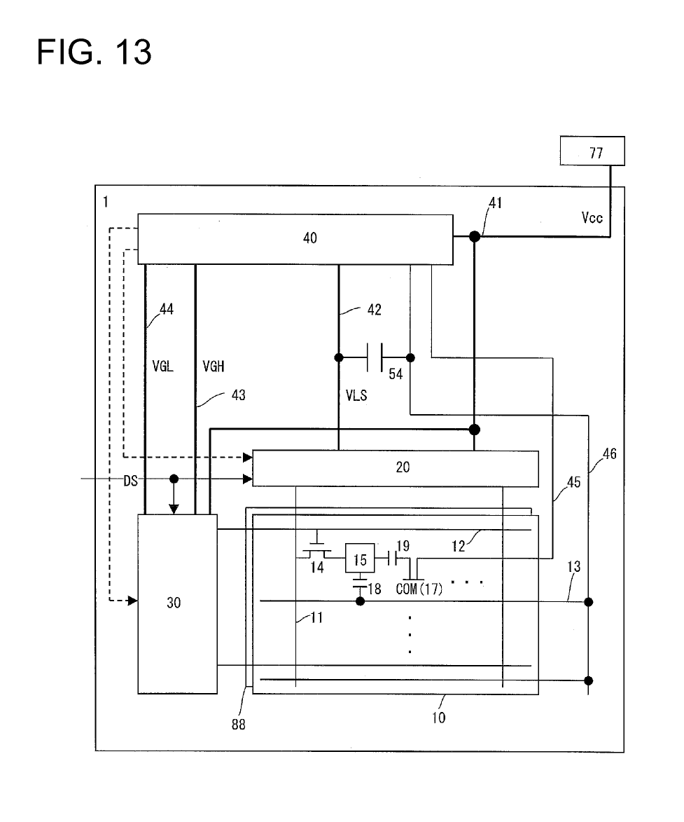

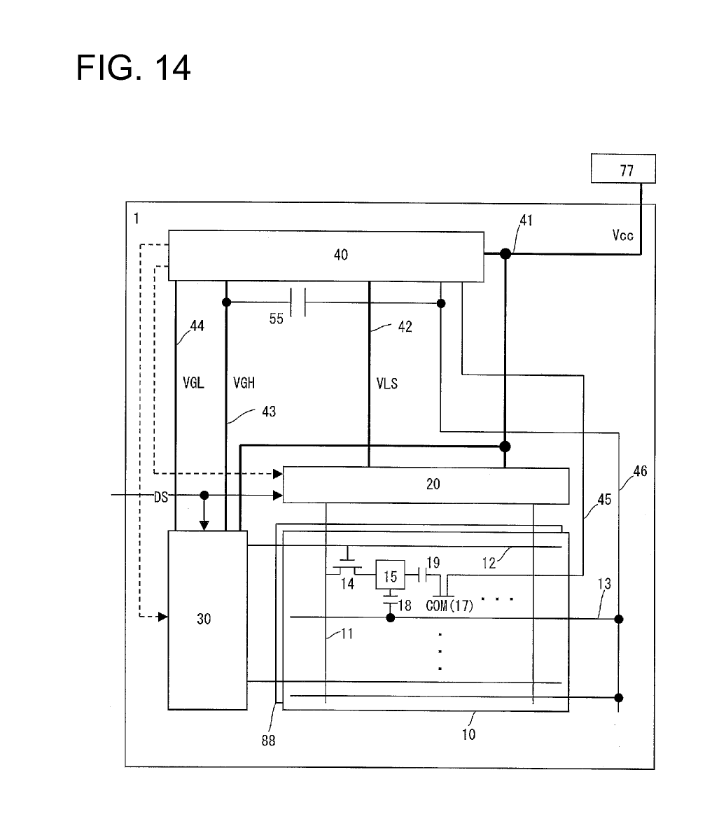

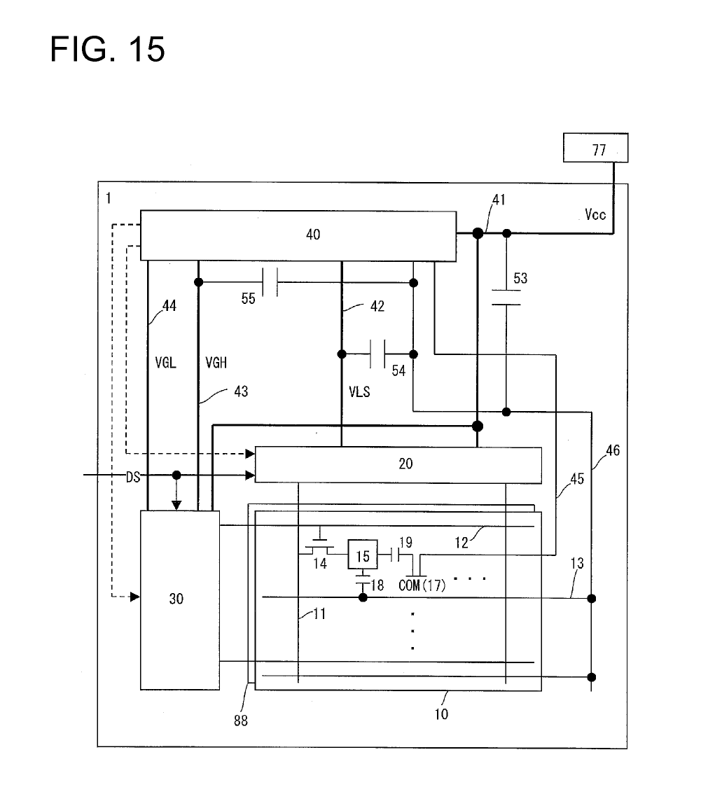

In addition, since the effect of reducing a residual image is dependent upon the voltage decrease (potential difference) of the system power supply and on the speed of the decrease (decrease in voltage per unit time) after the power supply is turned off, if there is power supply wiring for which voltage decrease and decrease speed are greater than for the system power supply when the power supply is turned off, this power supply wiring and the auxiliary capacitance wiring lines 13 may be connected to each other via a capacitance. For example, in FIG. 13, the power supply wiring 42 through which the analog power supply potential VLS is supplied and the auxiliary capacitance wiring lines 13 are connected to each other via a capacitance 54. Since VLS is generally a higher potential than Vcc and decreases by a greater amount when the power supply is turned off, the effect of reducing a residual image is also larger. For example, in FIG. 14, the power supply wiring 43 through which the gate-on power supply potential VGH is supplied and the auxiliary capacitance wiring lines 13 are connected to each other via a capacitance 55. In addition, in FIG. 15, the power supply wiring 41 through which the system power supply Vcc is supplied and the auxiliary capacitance wiring lines 13 are connected to each other via a capacitance 53, the power supply wiring 42 through which the analog power supply potential VLS is supplied and the auxiliary capacitance wiring lines 13 are connected to each other via the capacitance 54, and the power supply wiring 43 through which the gate-on power supply potential VGH is supplied and the auxiliary capacitance wiring lines 13 are connected to each other via the capacitance 55.

### Embodiment 3

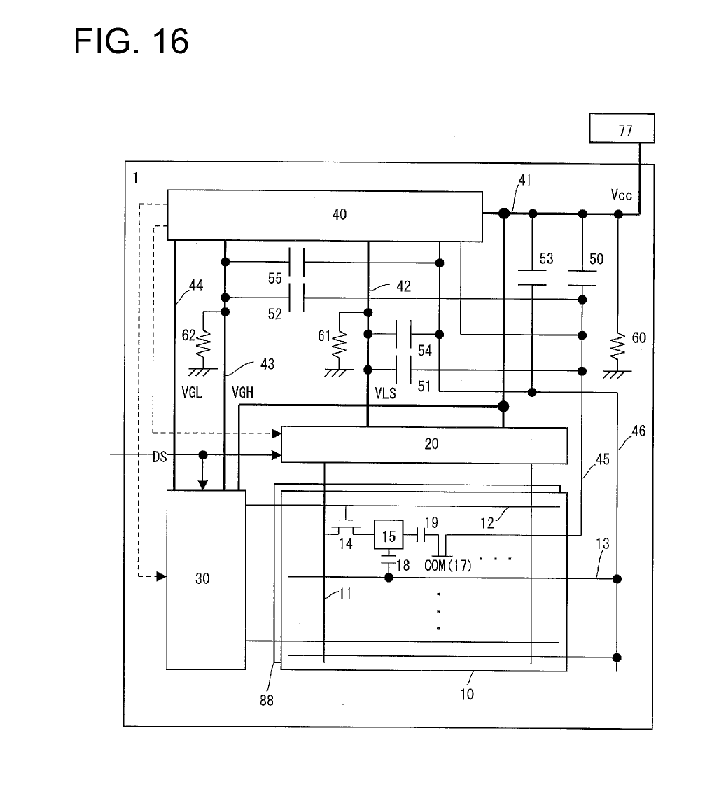

In Embodiment 3, as illustrated in FIG. 16, the power supply wiring 41 through which the system power supply Vcc is supplied and the common electrode 17 are connected to each other via a capacitance 50, the power supply wiring 42 through which the analog power supply potential VLS is supplied and the common electrode 17 are connected to each other via a capacitance 51, and the power supply wiring 43 through which the gate-on power supply potential VGH is supplied and the common electrode 17 are connected to each other via a capacitance 52. In addition, the power supply wiring 41 and the auxiliary capacitance wiring lines 13 are connected to each other via the capacitance 53, the power supply wiring 42 and the auxiliary capacitance wiring lines 13 are connected to each other via the capacitance 54, and the power supply wiring 43 and the auxiliary capacitance wiring lines 13 are connected to each other via the capacitance 55. Furthermore, the power supply wiring 41 is connected to ground via the resistor 60, the power supply wiring 42 is connected to ground via a resistor 61, and the power supply wiring 43 is connected to ground via a resistor 62.

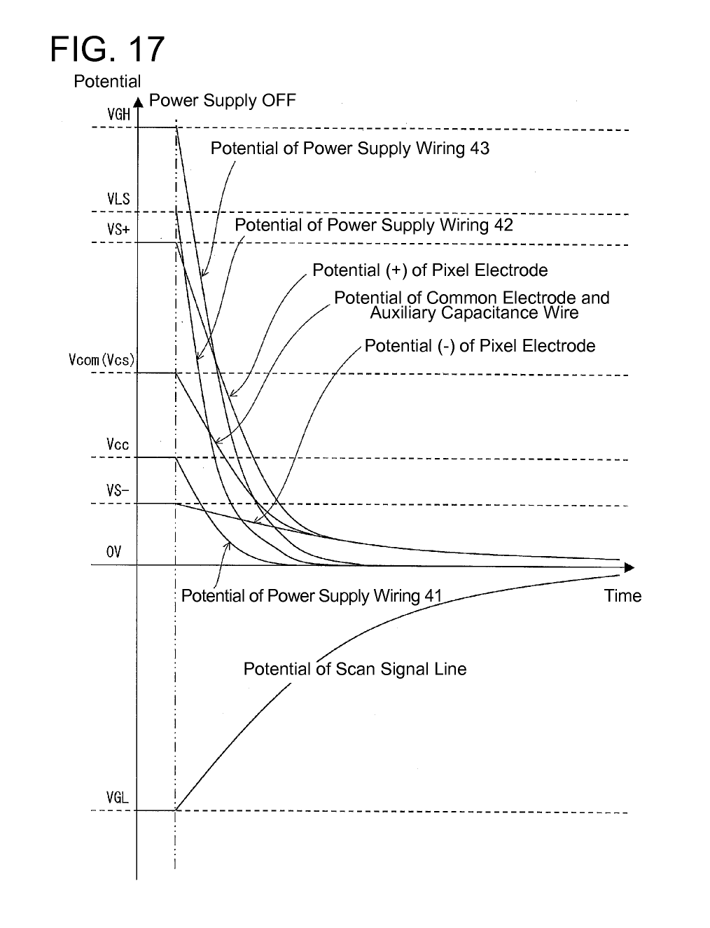

FIG. 17 is a signal waveform diagram illustrating an example of signal waveforms of individual parts of the liquid crystal display device 1 when the power supply is turned off.

In the normal operating state, the potentials of the respective parts are VGL, ground potential (0 V), VS−, Vcc, Vcs (Vcom), VS+, VLS and VGH in order from the low potential side as indicated on the left side of the two-dot slash line in FIG. 17 and there is no particular effect from the capacitances 50 to 55.

When the system power supply of the liquid crystal display device 1 is turned off, the outputs of the image signal line driver circuit 20 and the scan line driver circuit 30 transition to a high impedance state and the low-side potentials of the scan signal lines 12 slowly increase due to natural discharge. In contrast, since the system power supply potential rapidly decreases from Vcc, the analog power supply potential rapidly decreases from VLS and the gate on power supply potential rapidly decreases from VGH, the potential of the common electrode connected to the power supply wirings 41 to 43 via the capacitances 50 to 52 and the potentials of the auxiliary capacitance wiring lines 13 connected to the power supply wirings 41 to 43 via the capacitances 53 to 55 also rapidly decrease. Together with this, the potentials of the pixel electrodes 15 connected to the common electrode 17 via the liquid crystal capacitances 19 and connected to the auxiliary capacitance wiring lines 13 via the auxiliary capacitances 18 also very rapidly decrease. That is, compared to the related art (FIGS. 19 and 20), the potential of the source or drain with respect to the potential of the gate of the transistor 14 very rapidly decreases, and together with this, the OFF characteristics of the transistor 14 decrease. As a result, a leakage current between the pixel electrode 15 and the image signal line 11 becomes larger (charge of the pixel electrode 15 more easily escapes toward the image signal line 11 side). Thus, a potential difference between the pixel electrode 15 and the common electrode 17 more rapidly decreases than in the case in FIG. 19 and a residual image can be decreased. In addition, degradation of the liquid crystal panel 10 due to residual voltages of liquid crystal capacitance can also be suppressed. In Embodiment 3, each power supply potential is speedily decreased and the effect of reducing a residual image is further improved by providing the discharge resistors 60 to 62 as discharge circuits.

In FIG. 16, all of the capacitances 50 to 55 and the resistors 60 to 62 are provided, but the capacitances and resistors may be provided by being appropriately selected. For example, only the capacitance 50 and the resistor 60 may be provided or only the capacitance 51 and the capacitance 55 may be provided.

### SUMMARY

The greatest point of the present embodiments is that a residual image at the time when the power supply is turned off can be decreased by only adding a very small number of capacitances and adding resistors depending on the case, without adding a complex circuit such as a power supply off detection circuit. In addition, an oxide semiconductor (for example, an oxide semiconductor including indium, gallium and zinc) may be used in a channel of the transistors 14 of the liquid crystal panel 10. A transistor employing an oxide semiconductor generally has excellent OFF characteristics and a residual image on a liquid crystal panel equipped with such transistors when the power supply is turned off is easily visually recognized, and therefore a higher effect of suppressing a residual image can be expected in the above-described embodiments.

As described above, a liquid crystal display device includes a liquid crystal layer, a data signal line, a scan signal line, a transistor connected to the data signal line and the scan signal line, a pixel electrode connected to the data signal line via the transistor, a conductor and power supply wiring, the pixel electrode and the conductor being connected to each other via a first capacitance and the conductor and the power supply wiring being connected to each other via a second capacitance.

In the liquid crystal display device, the conductor may be a common electrode and the first capacitance may be a liquid crystal capacitance.

In the liquid crystal display device, the conductor may be an auxiliary capacitance wiring line and the first capacitance may be an auxiliary capacitance.

The liquid crystal display device may further include an auxiliary capacitance wiring line that is connected to the pixel electrode via an auxiliary capacitance and the auxiliary capacitance wiring line and the power supply wiring may be connected to each other via a third capacitance.

In the liquid crystal display device, the second capacitance may be a capacitance for rapidly extracting charge of the pixel electrode when the liquid crystal display device is turned off.

In the present liquid crystal display device, the power supply wiring may be connected to ground via a resistor.

In the liquid crystal display device, the power supply wiring may be wiring of an external power supply supplied from outside the liquid crystal display device.

In the liquid crystal display device, the power supply wiring may be wiring of an internal power supply generated inside the liquid crystal display device.

The liquid crystal display device may include a source driver that drives the data signal line, the internal power supply being supplied to the source driver.

In the liquid crystal display device, a signal potential may be generated by using a potential of the internal power supply.

The liquid crystal display device may include a gate driver that drives the scan signal line, the internal power supply being supplied to the gate driver.

In the liquid crystal display device, the potential of the internal power supply may be a potential that causes the transistor to be turned on.

A display device includes a display panel including a plurality of scan signal lines and a plurality of image signal lines provided so as to intersect each other, switching elements provided at positions near intersections of the scan signal lines and the image signal lines, controlled by scan signals from the scan signal lines and that switch image signals from the image signal lines, pixel electrodes provided for all the switching elements and connected to the image signal lines via the switching elements, and a common electrode provided so as to oppose the pixel electrodes with a display medium interposed therebetween, a capacitance being provided between a liquid crystal system power supply Vcc and the common electrode so that a potential of one electrode side of the common electrode opposing the switching elements is rapidly decreased when the power supply is turned off.

A display device includes a display panel including a plurality of scan signal lines and a plurality of image signal lines provided so as to intersect each other, switching elements provided at positions near intersections of the scan signal lines and the image signal lines, controlled by scan signals from the scan signal lines and that switch image signals from the image signal lines, pixel electrodes provided for all the switching elements and connected to the image signal lines via the switching elements, and a common electrode provided so as to oppose the pixel electrodes with a display medium interposed therebetween, a capacitance being provided between an analog power supply VLS input to a source driver and the common electrode so that a potential of one electrode side of the common electrode opposing the switching elements is rapidly decreased when the power supply is turned off.

A display device includes a display panel including a plurality of scan signal lines and a plurality of image signal lines provided so as to intersect each other, switching elements provided at positions near intersections of the scan signal lines and the image signal lines, controlled by scan signals from the scan signal lines and that switch image signals from the image signal lines, pixel electrodes provided for all the switching elements and connected to the image signal lines via the switching elements, and a common electrode provided so as to oppose the pixel electrodes with a display medium interposed therebetween, a capacitance being provided between a high-side power supply VGH of a gate driver and the common electrode so that a potential of one electrode side of the common electrode opposing the switching elements is rapidly decreased when the power supply is turned off.

A display device includes a display panel including a plurality of scan signal lines and a plurality of image signal lines provided so as to intersect each other, switching elements provided at positions near intersections of the scan signal lines and the image signal lines, controlled by scan signals from the scan signal lines and that switch image signals from the image signal lines, pixel electrodes provided for all the switching elements and connected to the image signal lines via the switching elements, a common electrode provided so as to oppose the pixel electrodes with a display medium interposed therebetween, and auxiliary capacitance units connected to the switching elements, a capacitance being provided between a liquid crystal system power supply Vcc and one electrode side of the auxiliary capacitance units so that a potential of the one electrode side of the auxiliary capacitance units opposing the switching elements is rapidly decreased when the power supply is turned off.

A display device includes a display panel including a plurality of scan signal lines and a plurality of image signal lines provided so as to intersect each other, switching elements provided at positions near intersections of the scan signal lines and the image signal lines, controlled by scan signals from the scan signal lines and that switch image signals from the image signal lines, pixel electrodes provided for all the switching elements and connected to the image signal lines via the switching elements, a common electrode provided so as to oppose the pixel electrodes with a display medium interposed therebetween and auxiliary capacitance units connected to the switching elements, a capacitance being provided between an analog power supply VLS input to a source driver and the common electrode so that a potential of one electrode side of the auxiliary capacitance units opposing the switching elements is rapidly decreased when the power supply is turned off.

A display device includes a display panel including a plurality of scan signal lines and a plurality of image signal lines provided so as to intersect each other, switching elements provided at positions near intersections of the scan signal lines and the image signal lines, controlled by scan signals from the scan signal lines and that switch image signals from the image signal lines, pixel electrodes provided for all the switching elements and connected to the image signal lines via the switching elements, a common electrode provided so as to oppose the pixel electrodes with a display medium interposed therebetween and auxiliary capacitance units connected to the switching elements, a capacitance being provided between a high-side power supply VGH of a gate driver and the common electrode so that a potential of one electrode side of the auxiliary capacitance units opposing the switching elements is rapidly decreased when the power supply is turned off.

The liquid crystal system power supply Vcc refers to a power supply (Vcc 41) supplied to the liquid crystal display device 1 from a user (set) side. Usually, voltages such as VLS, VGH and VGL are generated inside the liquid crystal display device by DC/DC, a charge pump and so forth on the basis of this Vcc 41. In addition, “an analog power supply VLS input to a source driver” refers to an analog power supply (VLS 42) of the signal line driver circuit 20 that outputs a certain analog voltage to the pixel signal lines 11 of the liquid crystal 10. Furthermore, “a high-side power supply VGH of a gate driver” refers to a power supply (VGH 43) that supplies a high-level (selected level) voltage to be output to the scan signal lines 12 of the liquid crystal 10 from the scan line driver circuit 30.

Embodiments of the present invention have been described above, but the present invention is not limited to the above-described embodiments. Various modifications are possible within the scope described in the claims and embodiments obtained by appropriately combining technical units disclosed in different embodiments are included in the technical scope of the present invention.

### INDUSTRIAL APPLICABILITY

The present invention is suitable for liquid crystal display devices used in personal computer, mobile telephone, smartphone, digital camera and television apparatuses.

### DESCRIPTION OF REFERENCE CHARACTERS

1 liquid crystal display device

11 image signal line

12 scan signal line

13 auxiliary capacitance wiring line

14 transistor

15 pixel electrode

16 liquid crystal layer

17 common electrode

18 auxiliary capacitance

10 liquid crystal panel

20 signal line driver circuit

30 scan line driver circuit

40 liquid crystal driver circuit

50 to 55 capacitance

60 to 62 resistor

1. A liquid crystal display device, comprising:
a liquid crystal layer;
a data signal line;
a scan signal line;
a transistor connected to the data signal line and the scan signal line;
a pixel electrode connected to the data signal line via the transistor;
a conductor connected to the pixel electrode via a first capacitor; and
a power supply wiring line,
wherein the conductor and the power supply wiring line are connected to each other via a second capacitor.

2. The liquid crystal display device according to claim 1, wherein the conductor is a common electrode and the first capacitor is a liquid crystal capacitor.

3. The liquid crystal display device according to claim 1, wherein the conductor is an auxiliary capacitance wiring line and the first capacitor is an auxiliary capacitor.

4. The liquid crystal display device according to claim 2, further comprising:
an auxiliary capacitance wiring line connected to the pixel electrode via an auxiliary capacitor,
wherein the auxiliary capacitance wiring line and the power supply wiring line are connected to each other via a third capacitor.

5. The liquid crystal display device according to claim 1, wherein the second capacitor is a capacitor for rapidly extracting charge in the pixel electrode when the liquid crystal display device is turned OFF.

6. The liquid crystal display device according to claim 1, wherein the power supply wiring line is connected to ground via a resistor.

7. The liquid crystal display device according to claim 1, wherein the power supply wiring line is wiring of an external power supply supplied from outside the liquid crystal display device.

8. The liquid crystal display device according to claim 1, wherein the power supply wiring line is wiring of an internal power supply generated inside the liquid crystal display device.

9. The liquid crystal display device according to claim 8, further comprising:
a source driver that drives the data signal line,
wherein the internal power supply is supplied to the source driver.

10. The liquid crystal display device according to claim 9, wherein a signal potential is generated in accordance with a potential of the internal power supply.

11. The liquid crystal display device according to claim 8, further comprising:
a gate driver that drives the scan signal line,
wherein the internal power supply is supplied to the gate driver.

12. The liquid crystal display device according to claim 11, wherein a potential of the internal power supply is a potential that causes the transistor to be turned ON.
